(19) United States
(12) Patent Application Publication
(10) Pub. No.: US 2014/0022872 A1
(43) Pub. Date: Jan. 23, 2014

(54) ACTUATING MECHANISM FOR A TIMEPIECE MOVEMENT AND CORRESPONDING TIMEPIECE MOVEMENT

(71) Applicant: PEQUIGNET S.A., Morteau (FR)

(72) Inventors: Huy Van Tran, La Chaux-de-Fonds (CH); Ludovic Perez, Villers-le-Lac (FR)

(73) Assignee: PEQUIGNET S.A., Morteau (FR)

(21) Appl. No.: 14/034,362

(22) Filed: Sep. 23, 2013

Related U.S. Application Data
(63) Continuation of application No. PCT/EP2012/055267, filed on Mar. 23, 2012.

(30) Foreign Application Priority Data
Mar. 23, 2011 (FR) 1152401

(51) Int. Cl. G04B 19/24

(52) U.S. Cl. CPC G04B 19/24
USPC 368/37

(57) ABSTRACT

An actuating mechanism for a timepiece movement is disclosed. The actuating mechanism may include a first mobile driven by a driving mobile of the timepiece movement, and a second mobile mounted to rotate on a frame element of the timepiece movement and control a displacement of at least one driven mobile of the timepiece movement to actuate at least one additional mechanism. In addition, an elastic member may be provided to act on the second mobile and define a rest position thereof.

This application is a continuation application of prior International

Application No. PCT/EP2012/055267, filed Mar. 23, 2012 and claiming priority to French (FR) Patent Application No. 1152401, filed Mar. 23, 2011. The disclosures of the above-referenced applications are expressly incorporated herein by reference to their entireties.

### TECHNICAL FIELD

The present disclosure relates to the field of timepieces. More particularly, and without limitation, the present disclosure relates to an actuating mechanism for a timepiece movement. The actuating mechanism may include a first mobile driven by a driving mobile of the timepiece movement, and a second mobile mounted to rotate on a frame element of the timepiece movement and to control a displacement of at least one driven mobile of the timepiece movement to actuate at least one additional mechanism. The first mobile may include first and second sets of teeth, attached in rotation and respectively defining first and second levels that can cooperate respectively with the driving mobile and the second mobile. In some embodiments, the first mobile may take the form of a wheel provided with the set of teeth at its periphery.

The present disclosure also relates to a timepiece movement provided with such an actuating mechanism, as well as a timepiece comprising such a timepiece movement.

### BACKGROUND

Mechanisms for timepieces have been disclosed, including in relation to a perpetual date indication. As an example, the patent application EP 1351104A1 and the patent CH 680630A3, to which the European application refers, present a mobile on which all the teeth except one are truncated in the radial direction. All the teeth cooperate with a first, driving, mobile, whereas only the full tooth cooperates with a second, driven, mobile.

This type of mobile is relatively commonplace in date display mechanisms, but is fairly rare in other applications.

### SUMMARY

The present disclosure includes embodiments that improve on conventional solutions and provide an alternative to applications implementing mobiles with a plurality of levels of sets of teeth, by proposing a mechanism comprising such a mobile and having a different operating kinematic, aiming in particular to actuate an additional mechanism of the corresponding timepiece movement.

The present disclosure relates more particularly to embodiments of an actuating mechanism of the type mentioned above, which may also comprise an elastic member arranged to act on the second mobile and define a rest position thereof, in which the second mobile may be situated in reach of the second set of teeth but out of reach of the first set of teeth. The second set of teeth may further include a predefined pitch such that the second mobile can be pivoted in response to a displacement of the first mobile before returning to its rest position between two teeth of the second set of teeth.

In some embodiments, the first and second sets of teeth of the mobile may be arranged in the direction of the thickness of the first mobile defining first and second stages of sets of teeth.

By virtue of these features, the first mobile can be arranged in a timepiece movement to be driven by a driving mobile, cooperating with a first stage of sets of teeth, to control the displacements of the second mobile by the second stage of sets of teeth, the second mobile exhibiting a reciprocating movement between at least one pivoted position and one rest position.

In particular, provision can be made for the second mobile to be a rocker advantageously comprising a nose arranged to cooperate with the second set of teeth of the first mobile.

Moreover, the elastic member may comprise an abutment surface arranged to cooperate with a suitable bearing surface formed on the rocker to define the rest position thereof.

According to some embodiments, the rocker may pivot in respective first and second directions of rotation depending on whether the first mobile is driven, respectively, in a first and in a second direction of rotation.

By virtue of these features, the rocker can either actuate an additional mechanism of the corresponding timepiece movement, in first and second opposite directions, or actuate two distinct additional mechanisms, according to the direction in which it is itself driven by the first mobile.

To this end, the rocker may advantageously comprise a second nose that can act on a first driven mobile of the timepiece movement when the rocker pivots in the first direction of rotation and a third nose that can act on a second driven mobile of the timepiece movement when the rocker pivots in the second direction of rotation.

In particular, provision can be made for the actuating mechanism according to the disclosure to be a mechanism for correcting one or two indications of a timepiece movement, such as, for example, the date and the day of the week. In this case, a first pivoting direction of the rocker is associated with the correction of the date, whereas the second pivoting direction of the rocker is associated with the correction of the day of the week.

Moreover, the present disclosure relates to a timepiece movement that may be provided with an actuating mechanism of the type described herein, associated with a first additional mechanism configured to control the displacements of the first mobile and at least one second additional mechanism configured to be actuated from a movement of the rocker.

The first mobile can be produced as two toothed members, added on and securely attached in the general direction of the displacements of the mobile. Advantageously, the first mobile can be produced in the form of a toothed member, of which certain teeth are truncated.

According to some embodiments, the first mobile may be a toothed wheel, of which certain teeth are truncated in the direction of the thickness of the mobile so as to define two sets of teeth distributed on two stages.

### BRIEF DESCRIPTION OF THE DRAWINGS

Other features and advantages of the present disclosure will become more clearly apparent on reading the following detailed description, given with reference to the appended drawings, which are provided by way of nonlimiting examples, and in which:

FIG. 1 shows a simplified perspective view of a construction detail of an exemplary mechanism that is part of an timepiece, according to an embodiment of the present disclosure;

FIG. 2 represents a simplified plan view of a part of a timepiece movement that may incorporate the exemplary mechanism of FIG. 1, in a first configuration;

FIG. 3 represents a simplified plan view of a part of a timepiece movement that may incorporate the exemplary mechanism of FIG. 1, in a second configuration; and

FIG. 4 represents a simplified plan view of a part of a timepiece movement that may incorporate the mechanism of FIG. 1, in a third configuration.

### DETAILED DESCRIPTION OF EMBODIMENTS

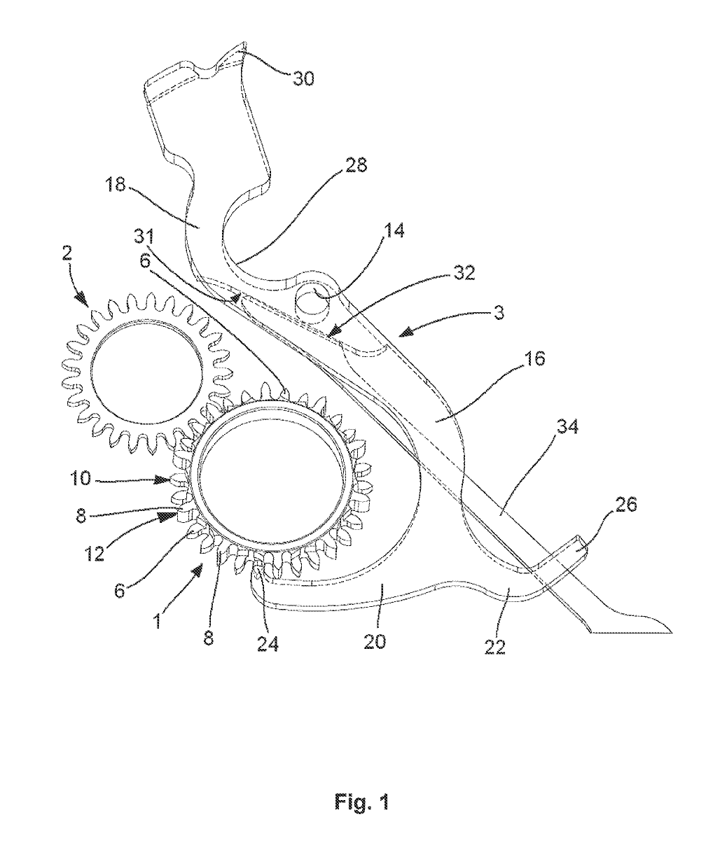

FIG. 1 represents a simplified perspective view of a construction detail of an exemplary mechanism that is part of a timepiece, according to an embodiment of the present disclosure.

More specifically, FIG. 1 illustrates a first mobile 1, according to one embodiment of the present disclosure, intended to be driven by a driving mobile 2 to actuate a second mobile 3. The mobiles 1 to 3 may be mounted to rotate on a frame element (not represented) of a timepiece movement, for example on the plate.

The first mobile 1 may take the form of a wheel, or of a crown ring, having a set of teeth at its periphery, here comprising 30 teeth, as a nonlimiting illustration.

As shown in FIG. 1, certain teeth 6 of the set of teeth may be truncated in the direction of the thickness of the first mobile 1. More specifically, two teeth out of three may be truncated, substantially at mid-height, so that one tooth 8 out of three is full.

Thus, the set of teeth may include a first set of teeth, or a first stage, 10, comprising both the truncated teeth 6 and the full teeth 8 and a second set of teeth, or a second stage, 12, comprising an alternation between full teeth 8 and voids due to the fact that two teeth out of three are truncated. In the case illustrated here, as a nonlimiting illustration, the pitch of the second stage is three times that of the first stage.

Obviously, it is possible to provide, as an alternative, for the first mobile 1 to be formed by two superposed plates securely attached in rotation, each of which would bear one of the sets of teeth 10, 12, without departing from the framework of the present disclosure.

The first stage 10 of the set of teeth may be configured to cooperate with the driving mobile to ensure rotational driving of the first mobile 1.

The second stage 12 of the set of teeth may be arranged to cooperate with the second mobile 3, here taking the form of a rocker that can be mounted to rotate on the frame of the timepiece movement, by means of a hole 14 intended to receive a screw (not shown). The hole 14 defines the axis of rotation of the rocker 3 with reference to the frame.

The rocker 3 may include two main arms 16, 18, the two main arms 16, 18 extending on either side of the hole 14 in generally substantially aligned directions.

The first arm 16 may extend initially in a direction slightly incurved before splitting into two branches 20, 22, respectively bearing first and second noses 24, 26 at their free ends.

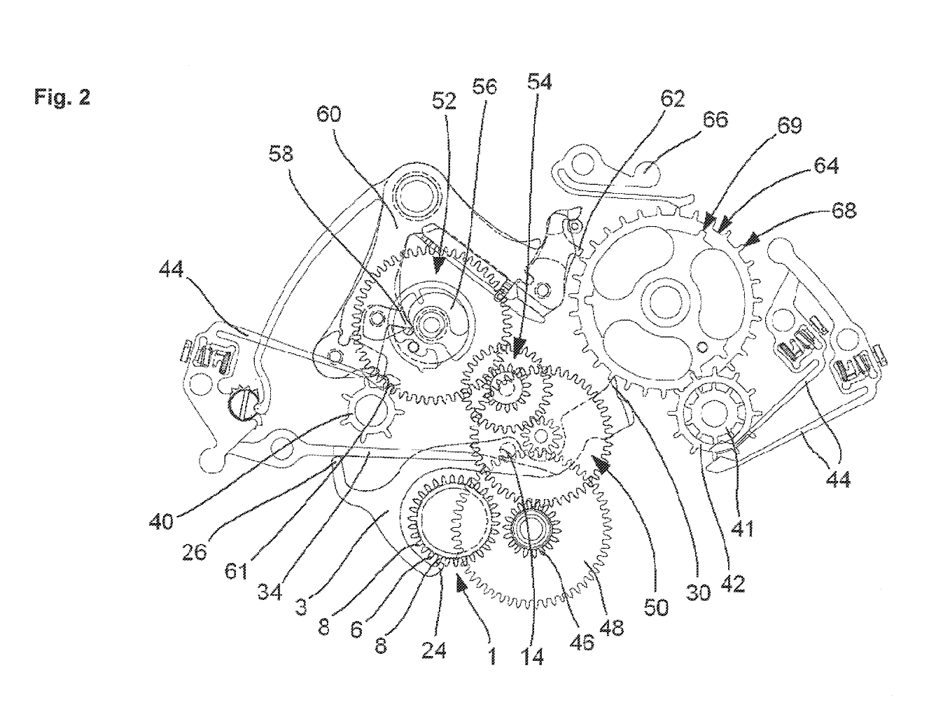

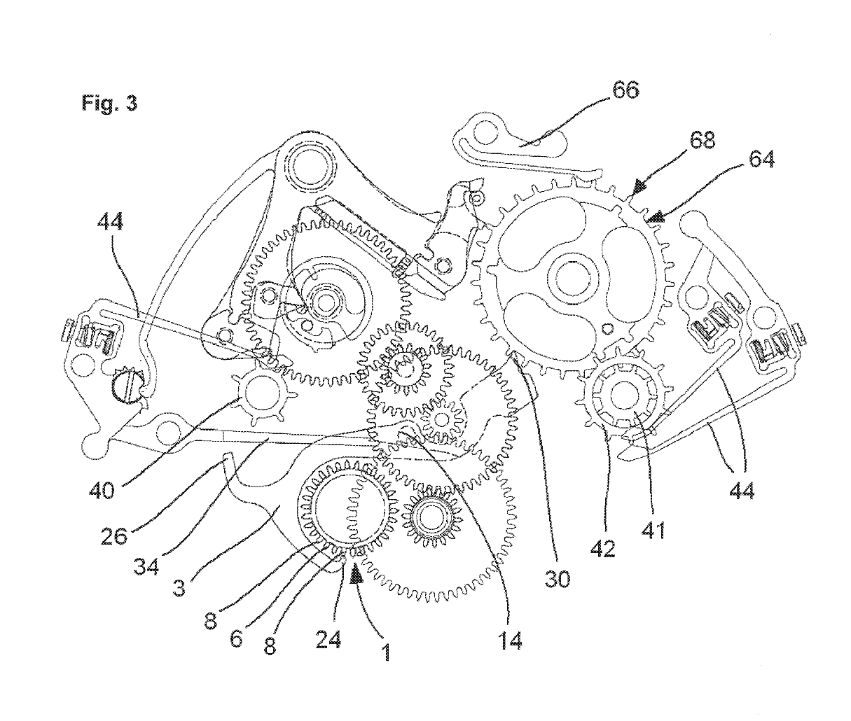

The second arm 18 may include an alignment discontinuity 28, which may be generally C-shaped and configured to avoid a collision of the rocker with another mobile of the timepiece movement, as shown in FIGS. 2 and 3, before being terminated by a third nose 30, the function of which will be explained later in relation to FIGS. 2 and 3.

The first nose 24 may be configured to cooperate with the set of teeth of the first mobile 1, as shown in FIG. 1, whereas the second nose 26 may be configured to cooperate with a driven mobile (not shown in FIG. 1).

More particularly, the first nose 24 may be arranged in a general plane of the second stage 12 of the set of teeth so as to cooperate only with the full teeth 8. The first set of teeth 10 may be situated in another plane, i.e., out of reach of the first nose 24.

Moreover, the rocker 3 may include two levels of thickness in its lengthwise direction to define a bearing surface 31, adjacent to the hole 14, and may be configured to cooperate with an abutment surface 32 of an elastic member 34 mounted on a frame element of the timepiece movement. The bearing 31 and abutment 32 surfaces may be substantially planar.

The elastic member 34 may be arranged to exert on the rocker 3 a force tending to position it in a rest position illustrated in FIG. 1, in which the first nose 24 may be arranged in reach of the second set of teeth 12 of the first mobile.

As shown in FIG. 1, if the first mobile 1 is driven in rotation in the clockwise direction, the full tooth 8 situated immediately to the side of the first nose 24 may come into contact therewith and exert on it a force tending to oppose the force of the elastic member 34 and to make the rocker 3 pivot in the clockwise direction.

Conversely, if the first mobile 1 is driven in rotation in the counter-clockwise direction, the first full tooth 8 situated to the left of the first nose 24 in FIG. 1 may come into contact therewith and exert on it a force tending to oppose the force of the elastic member 34 and to make the rocker 3 pivot in the counter-clockwise direction.

It will be understood from the above that, depending on whether the rocker pivots in one direction or the other, the second and third noses can act on additional mechanisms of the corresponding timepiece movement, as will emerge from the following description related to FIGS. 2 to 4.

FIGS. 2 to 4 show, in a nonlimiting manner, configurations of the exemplary actuating mechanism described above in relation to FIG. 1. In particular, FIGS. 2 to 4 show three different configurations of the exemplary actuating mechanism, each of which is described below.

FIGS. 2 to 4 illustrate, in a simplified manner, a part of a timepiece movement configured to allow for the display of the day of the week and of the date in large date form.

To this end, the timepiece movement may comprise mobiles or star wheels for the days 40, for the date units 41 and for the date tens 42, configured to be attached, respectively, to indicator disks for the days, for the date units and for the date tens (not represented). The angular positioning of each of the star wheels may be ensured by a jumper 44, as is known.

To ensure the driving of the star wheels 40 to 42, the timepiece movement may comprise a cannon pinion 46 and an hour wheel 48, kinematically linked by a motion work mobile 50. The motion work mobile 50 may drive a control mobile 52, via a reduction mobile 54. The control mobile 52 may be dimensioned so that the control mobile 52 makes one revolution on itself in 24 hours, as is known.

The control mobile 52 may comprise a spiral cam 56 configured to cooperate with a nose 58 of a control rocker 60 mounted to pivot on a frame element of the timepiece movement (in principle, a plate, not shown).

The control rocker 60 may comprise two pulls 61, 62 arranged to act respectively on the day star wheel 40 and a programmed wheel 64. More specifically, when the control mobile 52 rotates on itself, in the counter-clockwise direction of rotation in FIG. 2 and from its illustrated position, the cam 56 may progressively raise the nose 58 until a steep-sloped portion of the periphery of the cam 56, defining the junction between its portion of greatest radius and its portion of smallest radius, arrives facing the nose 58. At this instant, the nose 58 may fall to the portion of the cam 56 having the smallest radius, driving an abrupt pivoting of the control rocker 60 in the counter-clockwise direction of rotation.

This movement of the control rocker 60 may induce respective actions of the pull 61 on the day star wheel 40 and of the pull 62 on the programmed wheel 64 to make them advance by one step each, in a clockwise direction.

The stability of the angular position of the programmed wheel 64 may also be ensured by an additional jumper 66.

As is known, the programmed wheel 64 may comprise two sets of teeth 68, of thirty-one teeth, and 69, of four teeth, configured to act respectively on the star wheel for the date units 41 and for the date tens 42.

Thus, when the timepiece movement is operating, the star wheel for the days 40 and the programmed wheel 64 may be driven by one step per day to modify the displayed day and date.

The exemplary actuating mechanism described in relation to FIG. 1 may be incorporated in the timepiece movement represented in FIGS. 2 to 4 to fulfill the function of a mechanism for correcting the indication of the day of the week and of the date.

It will be noted that the actuating mechanism is shown in FIGS. 2 to 4 from its side opposite to that which was shown in FIG. 1.

The first mobile 1 and the rocker 3 may be arranged in the central region of the timepiece movement in such a way that the second nose 26 of the rocker 3 is situated in reach of the set of teeth of the day star wheel 40 and that the third nose 30 is situated in reach of the set of teeth 68 of the programmed wheel 64.

FIGS. 2 and 3 show the operating kinematics of the exemplary actuating mechanism according to the present disclosure when it is implemented to perform date correction.

To this end, the first mobile 1 may be driven in the counter-clockwise direction of rotation and may drive the rocker 3 in the same direction.

The third nose 30 may come into contact with the set of teeth 68 of the programmed wheel to induce a rotation thereof in the clockwise direction of rotation, i.e., to increase the value of the displayed date.

In the configuration shown in FIG. 2, the jump in the date is in progress, the third nose 30 is bearing against a tooth of the set of teeth 68 to oppose the force exerted by the jumper 66.

It will be noted that the alignment discontinuity 28 of the rocker 3 makes it possible to avoid a collision of the latter with the motion work mobile when correcting the date.

FIG. 3 shows a configuration at the end of a jump, when the jumper 66 has returned to a stable position between two teeth of the set of teeth 68. The tooth 8 is shown acting on the first nose 24 freeing the latter to allow the rocker 3 to return to its rest position, under the effect of the action of the elastic member 34. The return of the rocker to its rest position (as shown in FIG. 1) is possible by the fact that the second set of teeth 12 of the first mobile has a pitch that is big enough, for example three times that of the first set of teeth 10 as a nonlimiting illustration, for the first nose 24 of the rocker to be able to be lodged between two consecutive teeth 8.

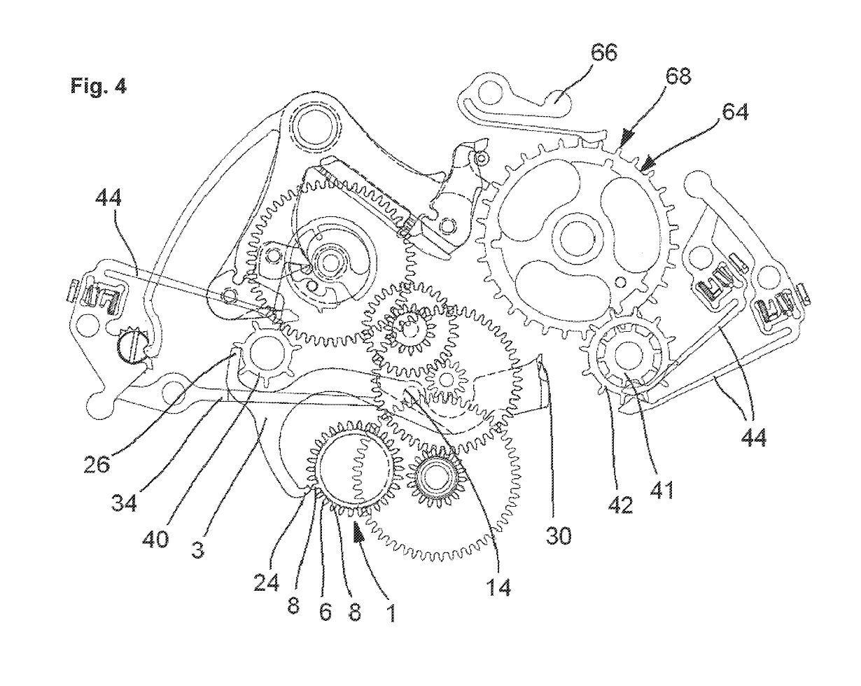

FIG. 4 shows the operating kinematics of the exemplary actuating mechanism according to the present disclosure when it is implemented to perform the correction of the day of the week.

To this end, the first mobile 1 may be driven in the clockwise direction of rotation and may drive the rocker 3 in the same direction by the pressure of a tooth 8 on the first nose 24.

As shown in FIG. 4, the second nose 26 of the rocker may be displaced to act on a tooth of the day star wheel 40 and rotate the latter in the clockwise direction of rotation to increment the indication of the day of the week by one day.

When the tooth 8 passes beyond the first nose 24, the rocker 3 may return to its rest position, between two teeth 8, under the effect of the action of the elastic member 34.

It is obvious that, in one direction of rotation or the other, when the first mobile is driven in a prolonged manner, the rocker 3 may exhibit an oscillating movement between its rest position and one of the correction positions, to increment either the date or the day of the week by a number of steps.

A person skilled in the art will not have any particular difficulty in implementing an additional mechanism intended to ensure the rotational driving of the first mobile 1. According to one embodiment, the corresponding timepiece may comprise an external control member, advantageously a rotary crown ring for rewinding and/or setting the time that occupies a plurality of axial positions, as is known. Thus, one of these axial positions can be provided in such a way as to establish a kinematic link, notably by means of a coupling pinion, between a rod attached in rotation to the rewinding crown ring and the first mobile 1. Because of this, each direction of rotation of the crown ring may be associated with a particular direction of rotation of the first mobile 1, in order to correct either the date or the day of the week.

It will be noted that a person skilled in the art will also be able to adapt the gearing-down ratio of this kinematic link according to his or her own needs, as well as the pitch of the second set of teeth 12 of the first mobile 1. The number of truncated teeth 6 provided between two consecutive full teeth 8 must be sufficient to allow the rocker 3 to return to its rest position between two successive actuations. In addition to the form and the dimensions of the first nose 24, this number may depend on the diameter of the first mobile 1. However, it will be noted that, in the case illustrated, as a nonlimiting example, this number of truncated teeth 6 situated between two successive full teeth 8 may be equal to or greater than one, generally, without departing from the framework of the present disclosure. Alternatively or complementarily, the number of full teeth may be equal to or greater than one. In the case of a smaller number of full teeth, it may be necessary to turn the rewinding crown ring more to perform correction increments.

The above description sets out to describe particular embodiments as nonlimiting illustrations, and the disclosure is not limited to the implementation of certain particular features described above, such as, for example, the quantity or the nature of the information items displayed. Similarly, the forms represented for the different constituents of the actuating mechanism according to the present disclosure are not limiting, notably that of the rocker 3.

A person skilled in the art will not have any particular difficulty in adapting the content of the present disclosure to his or her own needs and implementing an actuating mechanism comprising a first mobile comprising two sets of teeth, one to allow it to be driven and the other to drive a second mobile arranged to pivot, under the effect of the action of an elastic member, between a rest position and at least one actuating position, in which it can act on an additional mechanism, without departing from the framework of the present disclosure.

As a nonlimiting illustrative example, it will be recalled that the two sets of teeth of the first mobile may alternatively be produced by the assembly of two superposed wheels attached in rotation to one another. In addition, it is also possible for the two levels defined by these sets of teeth to be levels taken in the radial direction of the sets of teeth, in other words for the teeth of one of the two sets of teeth to be longer than those of the other. For example, provision can be made for the first mobile to comprise a single set of teeth of which certain teeth are truncated. These two sets of teeth may thus be equally situated in different planes or in one and the same plane to implement the mechanism according to the present disclosure.

As mentioned above, it is also possible to provide for the rocker 3 to be arranged to actuate only a single additional mechanism, either in a single direction with a single nose, or in two opposite directions, the rocker in this case having two noses arranged to act in two opposite directions on the same mechanism.

Moreover, it will be noted that the present disclosure is not limited to a first mobile having the form of a wheel. In practice, it is possible to implement the features described above on a rack or a rake without departing from the framework of the disclosure, for example. Similarly, the driven mobiles 40 and 64 may also exhibit linear displacements without departing from the framework of the present disclosure.

What is claimed is:

1. An actuating mechanism for a timepiece movement comprising:
a first mobile driven by a driving mobile of the timepiece movement;
a second mobile mounted to rotate on a frame element of the timepiece movement and control a displacement of at least one driven mobile of the timepiece movement to actuate at least one additional mechanism;
said first mobile comprising first and second sets of teeth, attached in rotation and, respectively defining first and second levels configured to cooperate respectively with the driving mobile and said second mobile, said first mobile taking the form of a wheel provided with said first and second sets of teeth at its periphery;
the actuating mechanism further comprising an elastic member configured to act on said second mobile and define a rest position thereof, in which said second mobile is situated in reach of said second set of teeth but out of reach of said first set of teeth;
said first and second sets of teeth being contiguous; and
said second set of teeth having a predefined pitch such that said second mobile is configured to be pivoted in response to a displacement of said first mobile before returning to its rest position between two teeth of said second set of teeth.

2. The actuating mechanism of claim 1, wherein said first and second sets of teeth are arranged in a direction of the thickness of said first mobile respectively defining first and second stages of sets of teeth.

3. The actuating mechanism of claim 1, said second mobile being a rocker comprising a first nose arranged to cooperate with said second set of teeth.

4. The actuating mechanism of claim 3, wherein said elastic member comprises an abutment surface arranged to cooperate with a suitable bearing surface, formed on said rocker to define said rest position.

5. The actuating mechanism of claim 3, wherein said rocker is configured to pivot in a first or a second direction of rotation depending on whether said first mobile is driven, respectively, in the first direction or in the second direction of rotation.

6. The actuating mechanism of claim 5, wherein said rocker comprises a second nose configured to act on a first driven mobile of the timepiece movement when said rocker pivots in said first direction of rotation and a third nose configured to act on a second driven mobile of the timepiece movement when said rocker pivots in said second direction of rotation.

7. A timepiece movement comprising an actuating mechanism, the actuating mechanism comprising:
a first mobile driven by a driving mobile of the timepiece movement;
a second mobile mounted to rotate on a frame element of the timepiece movement and control a displacement of at least one driven mobile of the timepiece movement to actuate at least one additional mechanism;
said first mobile comprising first and second sets of teeth, attached in rotation and, respectively defining first and second levels configured to cooperate respectively with the driving mobile and said second mobile, said first mobile taking the form of a wheel provided with said first and second sets of teeth at its periphery;
said actuating mechanism also comprising an elastic member configured to act on said second mobile and define a rest position thereof, in which said second mobile is situated in reach of said second set of teeth but out of reach of said first set of teeth;
said first and second sets of teeth being contiguous;
said second set of teeth having a predefined pitch such that said second mobile is configured to be pivoted in response to a displacement of said first mobile before returning to its rest position between two teeth of said second set of teeth; and
the timepiece movement further comprising:
a first additional mechanism including a driving mobile that engages with said first set of teeth to drive said first mobile; and
at least one second additional mechanism including a driven mobile actuated by said second mobile.

8. The timepiece movement of claim 7, said first mobile being arranged on a frame element of the timepiece movement so as to pivotable with reference thereto, said second mobile being a rocker comprising a first nose arranged to cooperate with said second set of teeth and configured to pivot in a first direction or a second direction of rotation depending on whether said first mobile is driven, respectively, in the first direction or in the second direction of rotation,
wherein said rocker comprises a second nose arranged to act on a first driven mobile of the timepiece movement when said rocker pivots in said first direction of rotation and a third nose arranged to act on a second driven mobile of the timepiece movement when said rocker pivots in said second direction of rotation.

9. The timepiece movement of claim 8, wherein said first driven mobile cooperates with a mechanism for displaying a first information item and said second driven mobile cooperates with a mechanism for displaying a second information item.

10. A timepiece provided with a timepiece movement comprising an actuating mechanism, the actuating mechanism comprising:
a first mobile driven by a driving mobile of the timepiece movement;
a second mobile mounted to rotate on a frame element of the timepiece movement and control a displacement of at least one driven mobile of the timepiece movement to actuate at least one additional mechanism;
said first mobile comprising first and second sets of teeth, attached in rotation and, respectively defining first and second levels configured to cooperate respectively with the driving mobile and said second mobile, said first mobile taking the form of a wheel provided with said first and second sets of teeth at its periphery;
said actuating mechanism also comprising an elastic member configured to act on said second mobile and define a rest position thereof, in which said second mobile is situated in reach of said second set of teeth but out of reach of said first set of teeth;
said first and second sets of teeth being contiguous; and
said second set of teeth having a predefined pitch such that said second mobile is configured to be pivoted in response to a displacement of said first mobile before returning to its rest position between two teeth of said second set of teeth; and
the timepiece movement further comprising:
a first additional mechanism including a driving mobile that engages with said first set of teeth to drive said first mobile;
at least one second additional mechanism including a driven mobile actuated by said second mobile; and
an external control member kinematically linked to said first mobile to enable a user to control said actuating mechanism.

11. The actuating mechanism of claim 2, said second mobile being a rocker comprising a first nose arranged to cooperate with said second set of teeth.

12. The actuating mechanism of claim 11, wherein said elastic member comprises an abutment surface arranged to cooperate with a suitable bearing surface, and wherein said elastic member is formed on said rocker to define said rest position.

13. The actuating mechanism of claim 4, wherein said rocker is configured to pivot in a first direction or a second direction of rotation depending on whether said first mobile is driven, respectively, in the first direction or in the second direction of rotation.

14. The actuating mechanism of claim 11, wherein said rocker is configured to pivot in a first direction or a second direction of rotation depending on whether said first mobile is driven, respectively, in the first direction or in the second direction of rotation.

15. The actuating mechanism of claim 12, wherein said rocker is configured to pivot in a first direction or a second direction of rotation depending on whether said first mobile is driven, respectively, in the first direction or in the second direction of rotation.

16. The actuating mechanism of claim 13, wherein said rocker comprises a second nose configured to act on a first driven mobile of the timepiece movement when said rocker pivots in said first direction of rotation and a third nose configured to act on a second driven mobile of the timepiece movement when said rocker pivots in said second direction of rotation.

17. The actuating mechanism of claim 15, wherein said rocker comprises a second nose configured to act on a first driven mobile of the timepiece movement when said rocker pivots in said first direction of rotation and a third nose configured to act on a second driven mobile of the timepiece movement when said rocker pivots in said second direction of rotation.

18. The timepiece of claim 10, wherein
said first mobile is arranged on a frame element of the timepiece movement so as to be pivotable with reference thereto, said second mobile being a rocker comprising a first nose arranged to cooperate with said second set of teeth and configured to pivot in a first direction or a second direction of rotation depending on whether said first mobile is driven, respectively, in the first direction or in the second direction of rotation; and
said rocker comprises a second nose arranged to act on a first driven mobile of the timepiece movement when said rocker pivots in said first direction of rotation and a third nose configured to act on a second driven mobile of the timepiece movement when said rocker pivots in said second direction of rotation.

19. The timepiece of claim 18, wherein
said first driven mobile is arranged to cooperate with a mechanism for displaying a first information item; and
said second driven mobile is arranged to cooperate with a mechanism for displaying a second information item.
